(19) United States
(12) Patent Application Publication
(10) Pub. No.: US 2026/0058717 A1
(43) Pub. Date: Feb. 26, 2026

(54) BEAM INDICATION FOR REPEATER BACKHAUL LINK

(71) Applicant: Lenovo (Singapore) Pte. Limited, Singapore (SG)

(72) Inventors: Ali Ramadan Ali, Kraiburg am Inn (DE); Ahmed Hindy, Aurora, IL (US); Majid Ghanbarinejad, Chicago, IL (US); Vijay Nangia, Woodridge, IL (US)

(21) Appl. No.: 19/102,533

(22) PCT Filed: Aug. 10, 2023
(86) PCT No.: PCT/IB2023/058078

§ 371 Date: Feb. 10, 2025

Related U.S. Application Data
(60) Provisional application No. 63/371,070, filed on Aug. 10, 2022.

(51) Int. Cl. H04B 7/06; H04L 5/00; H04W 72/231

(52) U.S. Cl. CPC H04B 7/06968; H04L 5/0044; H04L 5/0098; H04W 72/231

(57) ABSTRACT

A repeater device: receives, via a control link from a network, configuration information for a repeater control resource set (CORESET) containing an indicator of spatial relation information for transmitting a repeated signal via: (i) a backhaul link to the network; or (ii) an access link to a UE. The configuration information is used to monitor the repeater CORESET received on the control link. Spatial relation information is decoded based on the indicator, and an offset determined between repeater DCI on the repeater CORESET and one of: (i) a physical channel received by the device on the control link; or (ii) an Uplink radio frequency (RF) signal transmitted on the backhaul link; and (iii) a Downlink RF signal transmitted on the access link. A QCL assumption is applied to use spatial information associated with the first link and the repeater CORESET for receiving and transmitting physical channels on the backhaul link.

### PRIORITY APPLICATION

The application claims priority to U.S. Provisional Application No. 63/371,070 filed Aug. 10, 2022, the content of which is fully incorporated herein.

### TECHNICAL FIELD

The present disclosure relates to wireless communications, and more specifically to repeating wireless communication using receive-transmit beam pair selection.

### BACKGROUND

A wireless communications system may include one or multiple network communication devices, including base stations, which may be otherwise known as an eNodeB (eNB), a next-generation NodeB (gNB), or other suitable terminology. Each network communication device, such as a base station, may support wireless communications for one or multiple user communication devices, which may be otherwise known as user equipment (UE), or other suitable terminology. The wireless communications system may support wireless communications with one or multiple user communication devices by utilizing resources of the wireless communications system (e.g., time resources (e.g., symbols, slots, subframes, frames, or the like) or frequency resources (e.g., subcarriers, carriers). Additionally, the wireless communications system may support wireless communications across various radio access technologies including third generation (3G) radio access technology, fourth generation (4G) radio access technology, fifth generation (5G) radio access technology, and other suitable radio access technologies beyond 5G (e.g., sixth generation (6G)).

Coverage is a fundamental aspect of cellular network deployments. Mobile operators rely on different types of network nodes to offer blanket coverage in their deployments. Deployment of regular full-stack cells is one option but may not be always technically possible or economically viable. As a result, new types of network nodes have been considered to increase mobile operators'flexibility for their network deployments. For example, Integrated Access and Backhaul (IAB) is a new type of network node not requiring a wired backhaul. Another type of network node is a radio frequency (RF) repeater that simply amplifies-and-forwards any signal that the RF repeater receives. RF repeaters have seen a wide range of deployments in 2G, 3G and 4G to supplement the coverage provided by regular full-stack cells. The 5G New Radio (NR) radio access technologies (RATs) have RF and Electromagnetic Compatibility (EMC) requirements for such RF repeaters for NR targeting both Frequency Range 1 (FR1) and Frequency Range 2 (FR2).

### SUMMARY

The present disclosure relates to methods, apparatuses, and systems that provide procedures and signaling for a network-controlled repeater (NCR) to determine a beam indication received on a side control link from a network device. The NCR applies the beam indication to configuring NCR forwarding of wireless communication. The forwarding includes downlink radio frequency (RF) signals from the network device repeated to user equipment (UE) and includes uplink RF signals from the UE repeated to the network device. An association of a default beam of the control link is applied to forwarded physical channels controlled by an NCR mobile terminal downlink control information (DCI) in certain circumstances. Transmission Configuration Indicator (TCI) states are signaled for the forwarded physical channels when the side control information is received in a different component carrier or from a different Transmission and Reception Point (TRP). The beam indication enables improved communication performance by the NCR.

Some implementations of the method and apparatuses described herein may include a method for wireless communication by a repeater device. The method includes receiving, via at least one transceiver of the repeater device from at least one network node, configuration information for a repeater control resource set (CORESET). The repeater CORESET contains an indicator of spatial relation information to be applied to the transceiver in transmitting a repeated signal via one of: (i) a backhaul link to the network; and (ii) an access link to a user device, the at least one transceiver communicatively coupled to the at least one network node via: (i) a control link; and (ii) the backhaul link. The method includes configuring the at least one transceiver with the configuration information to monitor the repeater CORESET received on the control link. The method includes decoding the spatial relation information based on the indicator. The method includes determining an offset between a repeater downlink control information (DCI) on the repeater CORESET and a corresponding one of: (i) a physical channel received by the repeater device on the control link; (ii) an Uplink (UL) radio frequency (RF) signal transmitted by the repeater device on the backhaul link; or (iii) a Downlink (DL) RF signal transmitted by the repeater device on the access link. The method includes applying the spatial relation information to the at least one transceiver in response to the offset being less than a threshold offset value.

### BRIEF DESCRIPTION OF THE DRAWINGS

FIG. 1 illustrates an example of a wireless communications system enabling repeating of wireless communication by a network-controller repeater (NCR) device, in accordance with aspects of the present disclosure.

FIG. 2 illustrates a portion of the wireless communications system including a network device, the NCR device, and user equipment (UE) that is outside of a coverage area for the network device, in accordance with aspects of the present disclosure;

FIG. 3 illustrates the wireless communications system when a beam indication for a backhaul forward-link when spatial relation information is not present in NRC mobile terminal (MT) downlink control information (DCI), in accordance with aspects of the present disclosure.

FIG. 4 illustrates the wireless communications system when a beam indication for a backhaul forward-link when spatial relation information is present in NRC-MT DCI, in accordance with aspects of the present disclosure.

FIG. 5 illustrates the wireless communications system when a beam indication for a backhaul forward-link when spatial relation information is present in NRC-MT DCI for multiple Transmission and Reception Points (TRP), in accordance with aspects of the present disclosure.

FIG. 6 illustrates a block diagram of a device that performs repeating of wireless communication, in accordance with aspects of the present disclosure.

FIG. 7 illustrates a flowchart of a method performed by a user device that supports side wireless communication with reduced time for an access procedure when other technology is indicated as being absent, in accordance with aspects of the present disclosure.

### DETAILED DESCRIPTION

While a conventional RF repeater presents a cost-effective means of extending network coverage to a communications system, the RF repeater has its limitations. An RF repeater simply does an amplify-and-forward operation without being able to take into account various factors that could improve performance. Such factors may include information on semi-static and/or dynamic downlink/uplink configuration, adaptive transmitter/receiver spatial beamforming, ON-OFF status, etc. A network-controlled repeater (NCR) is an enhancement over conventional RF repeaters with the capability to receive and process side control information from the network. Side control information could allow NCR to perform the amplify-and-forward operation in a more efficient manner. Potential benefits could include mitigation of unnecessary noise amplification, transmissions and receptions with better spatial directivity, and simplified network integration. The NCR presents issues with implementing the additional functionality enabled by side control information.

A backhaul link and a control link between a network device and the NCR are generally expected experience the same large-scale properties of the channel. In particular, channel properties referred to a Type-A and Type-D (if applicable) are expected to be experienced by both the control link and the backhaul link, at least when the NCR mobile terminal (MT) that communicates via the control link and an NCR forwarding section that communicates via the backhaul link are operating in the same carrier. However, if the NCR-MT is working with a different frequency than at least one component carrier of the backhaul link, then an indication of a backhaul beam needs to be considered.

The present disclosure addresses the issue of indicating spatial relation information, Transmission Configuration Indicator (TCI), Quasi Co-location (QCL), and beam identifier (ID) for the backhaul link for situations when a component carrier (CC) for the NCR-MT and a CC for the NCR forwarding section are not on the same carrier of one network device or are separately transmitted by multiple Transmission and Reception Points (TRPs). A field for spatial relation information and beam ID to be applied on the forward backhaul link is included in a repeater specific Downlink Control Information (DCI) carried by a repeater specific Physical Downlink Control Channel (rPDCCH). The spatial relation information indicates the relation between receiving the control link (i.e., rPDCCH) and receiving and/or transmitting the Physical Downlink Control Channel (PDCCH), Physical Downlink Shared Channel (PDSCH), Physical Uplink Control Channel (PUCCH), Physical Uplink Shared Channel (PUSCH), and Sounding Reference Signal (SRS) in the backhaul link. A procedure is defined for the NCR to apply the spatial relation information, QCL, and beam IDs on the forwarded physical channels based on the offset between receiving and decoding rPDCCH carrying the control information and receiving the physical channels and applying the control information. The procedure for indicating and/or applying the spatial relation/beam IDs is based on whether the rPDCCH is transmitted from the same TRP or in the same CC or not. The NCR-MT is configured with side control information in an NCR-MT Control Resource Set (CORESET), wherein the CORESET is associated with a TCI/QCL assumption/beam ID for which the TCI/QCL assumption/beam ID is applicable as default beam for receiving the forwarded physical channels controlled by the DCI of that CORESET on the backhaul-link. A field for spatial relation information and beam ID to be applied on the forward link may be present in the DCI.

The spatial relation information indicates the relation between the spatial filter for receiving and transmitting physical channels in the forward backhaul link, or the spatial filter for receiving NCR-MT CORESET and receiving the forwarded physical channels. If the forwarded physical channels are on a different CC than the NCR-MT and the controlling DCI does not have the spatial relation information field present, and the time offset between receiving of that DCI and the corresponding forwarded physical channels of a serving cell is equal to or greater than a threshold “timeDurationForQCL”, the NCR assumes that the spatial relation information or Rx beam ID for the PDCCH/PDSCH is based on the beam ID associated with the NCR-MT CORESET. If the forwarded physical channels are on a different CC than the NCR-MT and the controlling DCI has the spatial relation information field present, and the time offset between receiving of that DCI and the corresponding physical channels is equal or greater than a threshold “timeDurationForQCL”, the NCR applies the spatial relation information of the beam ID indicated in the NCR-MT DCI.

The present disclosure thus provides a new procedure and signaling to allow association of a default beam of a control link to be applied for forwarded physical channels PDCCH/PDSCH/PUCCH/PUSCH controlled by an NCR-MT DCI. The present disclosure provides a new procedure and signaling of TCI states for the forwarded physical channels PDCCH/PDSCH/PUCCH/PUSCH when the side control information is received in a different component carrier or from a different TRP.

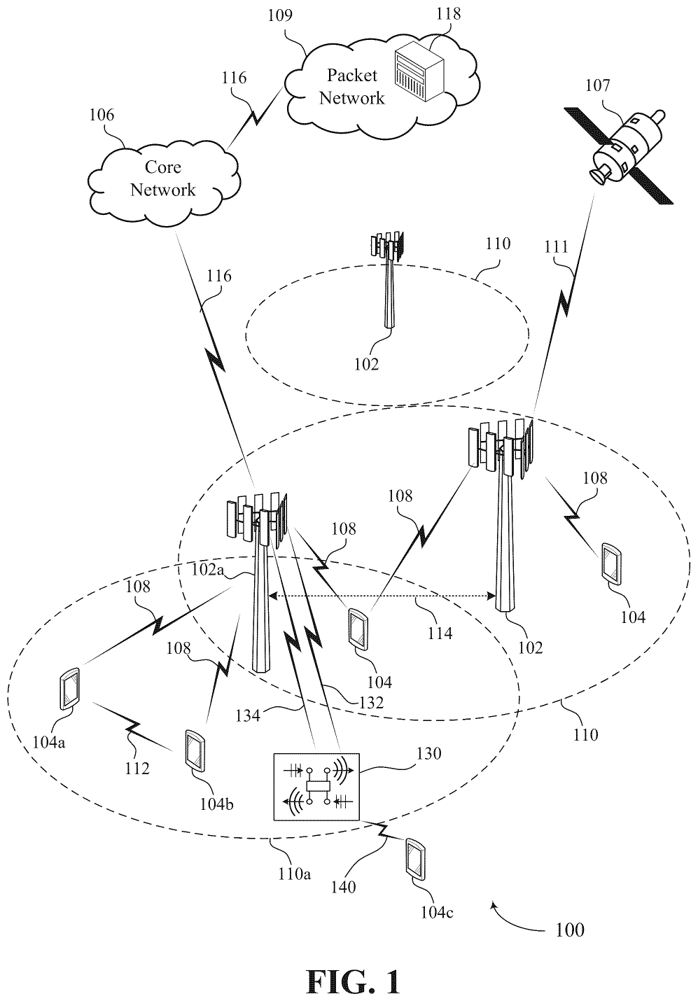

FIG. 1 illustrates an example of a wireless communications system 100 enabling repeating of wireless communication by a network-controller repeater (NCR) device, in accordance with aspects of the present disclosure. The wireless communications system 100 may include one or more network devices 102, one or more UEs 104, a core network 106, and a packet data network 109. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a 5G network, such as a New Radio (NR) network. In other implementations, the wireless communications system 100 may be a combination of a 4G network and a 5G network. The wireless communications system 100 may support radio access technologies beyond 5G, or other suitable radio access technology including Institute of Electrical and Electronics Engineers (IEEE) 802.11 (Wi-Fi), IEEE 802.16 (WiMAX), IEEE 802.20. Additionally, the wireless communications system 100 may support technologies, such as time division multiple access (TDMA), frequency division multiple access (FDMA), or code division multiple access (CDMA), etc.

The one or more network devices 102 may be dispersed throughout a geographic region to form the wireless communications system 100. One or more of the network devices 102 described herein may be, may include, or may be referred to as a network node, a base station, a network element, a radio access network (RAN), a base transceiver station, an access point, a NodeB, an eNodeB (eNB), a next-generation NodeB (gNB), a network device, or other suitable terminology. A network device 102 and a UE 104 may communicate via a communication link 108, which may be a wireless or wired connection. For example, a network device 102 and a UE 104 may wirelessly communicate (e.g., receive signaling, transmit signaling) over a user to user (Uu) interface.

A network device 102 may provide a geographic coverage area 110 for which the network device 102 may support services (e.g., voice, video, packet data, messaging, broadcast, etc.) for one or more UEs 104 within the geographic coverage area 110. For example, a network device 102 and a UE 104 may support wireless communication of signals related to services (e.g., voice, video, packet data, messaging, broadcast, etc.) according to one or multiple radio access technologies. In some implementations, a network device 102 may be moveable, for example, a satellite 107 associated with a non-terrestrial network and communicating via a satellite link 111. In some implementations, different geographic coverage areas 110 associated with the same or different radio access technologies may overlap, but the different geographic coverage areas 110 may be associated with different network devices 102. Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The one or more UEs 104 may be dispersed throughout a geographic region of the wireless communications system 100. A UE 104 may include or may be referred to as a mobile device, a wireless device, a remote device, a remote unit, a handheld device, or a subscriber device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples. In some implementations, a UE 104 may be stationary in the wireless communications system 100. In some other implementations, a UE 104 may be mobile in the wireless communications system 100.

The one or more UEs 104 may be devices in different forms or having different capabilities. Some examples of UEs 104 are illustrated in FIG. 1. A UE 104 may be capable of communicating with various types of devices, such as the network devices 102, other UEs 104, or network equipment (e.g., the core network 106, the packet data network 109, a relay device, an integrated access and backhaul (IAB) node, or another network equipment), as shown in FIG. 1. Additionally, or alternatively, a UE 104 may support communication with other network devices 102 or UEs 104, which may act as relays in the wireless communications system 100.

A UE 104a may also be able to support wireless communication directly with other UEs 104b over a communication link 112. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link 112 may be referred to as a sidelink. For example, a UE 104a may support wireless communication directly with another UE 104b over a PC5 interface. PC5 refers to a reference point where the UE 104a directly communicates with another UE 104b over a direct channel without requiring communication with the network device 102a.

A network device 102 may support communications with the core network 106, or with another network device 102, or both. For example, a network device 102 may interface with the core network 106 through one or more backhaul links 114 (e.g., via an S1, N2, or another network interface). The network devices 102 may communication with each other over the backhaul links 114 (e.g., via an X2, Xn, or another network interface). In some implementations, the network devices 102 may communicate with each other directly (e.g., between the network devices 102). In some other implementations, the network devices 102 may communicate with each other indirectly (e.g., via the core network 106). In some implementations, one or more network devices 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission and reception points (TRPs).

In some implementations, a network entity or network device 102 may be configured in a disaggregated architecture, which may be configured to utilize a protocol stack physically or logically distributed among two or more network entities or network devices 102, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity or network device 102 may include one or more of a central unit (CU), a distributed unit (DU), a radio unit (RU), a RAN Intelligent Controller (RIC) (e.g., a Near-Real Time RIC (Near-RT RIC), a Non-Real Time RIC (Non-RT RIC)), a Service Management and Orchestration (SMO) system, or any combination thereof.

An RU may also be referred to as a radio head, a smart radio head, a remote radio head (RRH), a remote radio unit (RRU), or a transmission and reception point (TRP). One or more components of the network entities or network devices 102 in a disaggregated RAN architecture may be co-located, or one or more components of the network entities or network devices 102 may be located in distributed locations (e.g., separate physical locations). In some implementations, one or more network entities or network devices 102 of a disaggregated RAN architecture may be implemented as virtual units (e.g., a virtual CU (VCU), a virtual DU (VDU), a virtual RU (VRU)).

Split of functionality between a CU, a DU, and an RU may be flexible and may support different functionalities depending upon which functions (e.g., network layer functions, protocol layer functions, baseband functions, radio frequency functions, and any combinations thereof) are performed at a CU, a DU, or an RU. For example, a functional split of a protocol stack may be employed between a CU and a DU such that the CU may support one or more layers of the protocol stack and the DU may support one or more different layers of the protocol stack. In some implementations, the CU may host upper protocol layer (e.g., a layer 3 (L3), a layer 2 (L2)) functionality and signaling (e.g., Radio Resource Control (RRC), service data adaption protocol (SDAP), Packet Data Convergence Protocol (PDCP)). The CU may be connected to one or more DUs or RUS, and the one or more DUs or RUs may host lower protocol layers, such as a layer 1 (L1) (e.g., physical (PHY) layer) or an L2 (e.g., radio link control (RLC) layer, medium access control (MAC) layer) functionality and signaling, and may each be at least partially controlled by the CU.

Additionally, or alternatively, a functional split of the protocol stack may be employed between a DU and an RU such that the DU may support one or more layers of the protocol stack and the RU may support one or more different layers of the protocol stack. The DU may support one or multiple different cells (e.g., via one or more RUs). In some implementations, a functional split between a CU and a DU, or between a DU and an RU may be within a protocol layer (e.g., some functions for a protocol layer may be performed by one of a CU, a DU, or an RU, while other functions of the protocol layer are performed by a different one of the CU, the DU, or the RU).

A CU may be functionally split further into CU control plane (CU-CP) and CU user plane (CU-UP) functions. A CU may be connected to one or more DUs via a midhaul communication link (e.g., F1, F1-c, F1-u), and a DU may be connected to one or more RUs via a fronthaul communication link (e.g., open fronthaul (FH) interface). In some implementations, a midhaul communication link or a fronthaul communication link may be implemented in accordance with an interface (e.g., a channel) between layers of a protocol stack supported by respective network entities or network devices 102 that are in communication via such communication links.

The core network 106 may support user authentication, access authorization, tracking, connectivity, and other access, routing, or mobility functions. The core network 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management for the one or more UEs 104 served by the one or more network devices 102 associated with the core network 106.

The core network 106 may communicate with the packet data network 109 over one or more backhaul links 116 (e.g., via an S1, N2, N2, or another network interface). The packet data network 109 may include an application server 118. In some implementations, one or more UEs 104 may communicate with the application server 118. A UE 104 may establish a session (e.g., a protocol data unit (PDU) session, or the like) with the core network 106 via a network entity or network device 102. The core network 106 may route traffic (e.g., control information, data, and the like) between the UE 104 and the application server 118 using the established session (e.g., the established PDU session). The PDU session may be an example of a logical connection between the UE 104 and the core network 106 (e.g., one or more network functions of the core network 106).

In the wireless communications system 100, the network entities or network devices 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the network entities or network devices 102 and the UEs 104 may support different resource structures. For example, the network entities or network devices 102 and the UEs 104 may support different frame structures. In some implementations, such as in 4G, the network entities or network devices 102 and the UEs 104 may support a single frame structure. In some other implementations, such as in 5G and among other suitable radio access technologies, the network entities or network devices or network devices 102 and the UEs 104 may support various frame structures (i.e., multiple frame structures). The network entities or network devices 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally, or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHz), FR2 (24.25 GHz-52.6 GHz), FR3 (7.125 GHz-24.25 GHz), FR4 (52.6 GHz-114.25 GHz), FR4a or FR4-1 (52.6 GHz-71 GHz), and FR5 (114.25 GHz-300 GHz). In some implementations, the network entities or network devices 102 and the UEs 104 may perform wireless communications over one or more of the operating frequency bands. In some implementations, FR1 may be used by the network entities or network devices 102 and the UEs 104, among other equipment or devices for cellular communications traffic (e.g., control information, data). In some implementations, FR2 may be used by the network entities or network devices 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g μ=2), which includes 60 kHz subcarrier spacing; and a fourth numerology (e.g., μ=3), which includes 120 kHz subcarrier spacing.

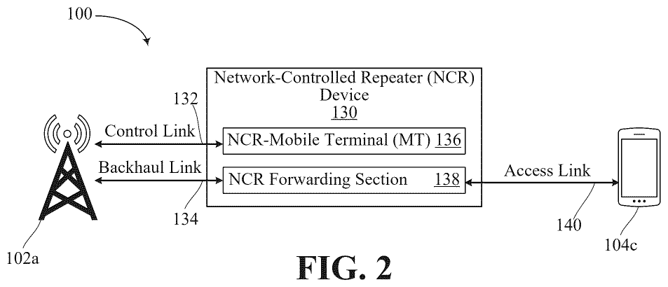

FIG. 2 illustrates a portion of the wireless communications system 100 including the network device 102a, an NCR device 130 and a UE 104c that is outside of a coverage area 110a (FIG. 1) for the network device 102a. With reference to FIGS. 1-2, wireless communications system 100 may extend a coverage area 110a for the network device 102a by including an NCR device 130 that is able to reach a UE 104c. NCR device 130 communicates with the network device 102a via both a side control link 132, which may be referred to as a “C-link”, and via a backhaul link 134. With particular reference to FIG. 2, the side control link 132 terminates at the NCR device 130 that accordingly acts as an NCR mobile terminal (NCR-MT) 136. The NCR device 130 includes an NCR forwarding section 138 that receives and amplifies a DL radio frequency (RF) signal received via the backhaul link 134 and forwards the DL RF signal with minimal delay via an access link 140 to the UE 104c. Similarly, the NCR forwarding section 138 receives and amplifies an UL RF signal received via the access link 140 and forwards the UL RF signal with minimal delay via the backhaul link to the network device 102a. The network device 102a is able to configure the NCR forwarding section 138 via configuration information sent via the side control link 132 to the NCR-MT 136.

Aspects of the present disclosure may apply more generally to communication links referred to with different labels. In one or more embodiments, the control link 132 may generally be a first link, the backhaul link 134 may generally be a second link, and the access link 140 may generally be a third link.

In a first embodiment (Embodiment 1), the present disclosure a backhaul link beam indication for an NCR. The NCR-MT is configured with side control information carried by a repeater specific CORESET. The CORESET is associated with a TCI, QCL assumption, and beam ID that is applicable as default beam for receiving the forwarded PDCCHs and PDSCHs (or the backhaul DL RF signal) and transmitting the PUCCHs and PUSCHs (or the backhaul UL/UL RF signal) controlled/indicated/scheduled by the DCI of the CORESET on the backhaul-link. In one example, the TCI, QCL assumption, and beam ID are applicable as a default beam for receiving the backhaul DL RF signal and amplifying and forwarding the backhaul UL RF signal. A TCI field for spatial QCL assumption, field for beam ID, or a spatial relation information to be applied on the NCR-Forward backhaul link maybe present or not in the side control information DCI based on the network configuration. In one example, the spatial relation information indicates the relation between the spatial filter for receiving and transmitting physical channels in the NCR-Forward backhaul link, or the spatial filter for receiving NCR-MT side control information CORESET and receiving the forwarded physical channels (e.g., via the backhaul DL RF signal) on the backhaul link. If a spatial relation information field is present in the side control information DCI, the NCR applies TCI state/spatial QCL assumption/beam ID, or a spatial relation information state for on all channels of the backhaul link for a corresponding component carrier associated with the spatial information. The DCI field may contain multiple spatial information for multiple component carriers.

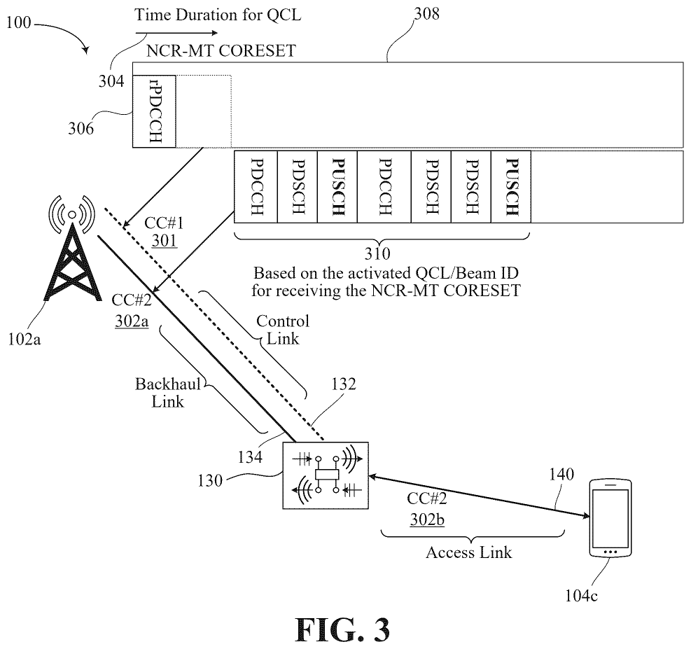

FIG. 3 illustrates the wireless communications system 100 when a beam indication for a backhaul forward-link when spatial relation information is not present in NRC-MT DCI. The network device 102a transmits a first CC (“CC #1”) 301 via the control link 132 and transmits a second CC (“CC #2”) 302a via the backhaul link 134 to the NCR device 130. The capabilities of the NCR-MT 136 (FIG. 2) are associated with a time duration for QCL value 304 that is relatively short, which indicates that the DCI can be decoded after receiving the rPDCCH 306 on NCR-MT CORESET 308 in CC #1 301 before the physical channels 310 are received or transmitted on the backhaul link on CC #2 302a. The physical channels 310 include PDCCH, PDSCH, PUSCH, PDCCH, PDSCH, PDSCH, and PUSCH. The NCR device 130 receives the physical channels based on the activated QCL, Beam ID for receiving the NCR-MT CORESET 308. NCR device 130 transmits a repeated CC #2 302b via the access link 140 to the UE 104c.

In one implementation, a determination is made whether the following conditions are present:
(i) the forwarded PDCCHs/PDSCHs/PUCCH/PUSCH (or the backhaul DL/UL RF signal) are on a different component carrier (CC) than the NCR-MT; and
(ii) the controlling (or side control information) DCI does not have the TCI state/spatial QCL assumption/beam ID, or a spatial relation information field present; and
(iii) the time offset between receiving of that DCI and the corresponding PDCCHs/PDSCHs/PUCCHs/PUSCHs (or the backhaul DL/UL RF signal) of a serving cell is equal to or greater than a threshold “timeDurationForQCL”,
where the threshold is based on the reported capability of the NCR-MT for decoding the side control information and applying the information on the forward link or NCR-Forward backhaul link, for determining spatial relation information/the antenna port quasi co-location for receiving PDCCH/PDSCH (or the backhaul DL RF signal) and/or transmitting PUCCH/PUSCH/SRS (or the backhaul UL RF signal). Although the NCR-MT could decode the spatial information from the DCI, the spatial information is not present.

When the conditions are present, the NCR assumes that the TCI state/spatial QCL assumption/beam ID, or a spatial relation information for the forwarded PDCCH/PDSCH/PUCCH/PUSCH/SRS (or the backhaul DL/UL RF signal) on the NCR-Forward backhaul link is based on the TCI/QCL/beam ID (associated with the NCR-MT CORESET used for transmitting the side control information)1, where rPDCCH represents the NCR-MT PDCCH.

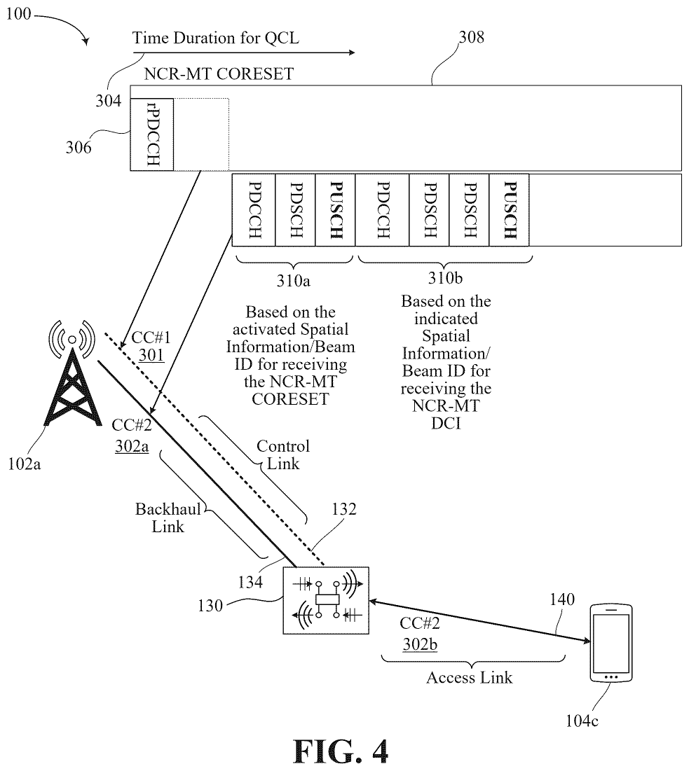

FIG. 4 illustrates the wireless communications system 100 when the beam indication for a backhaul forward-link when spatial relation information is present in NRC-MT DCI. The wireless communications system 100 is as described for FIG. 3 but with a longer time duration for QCL value that results in being unable to decode the spatial information in the DCI for the first portion of the physical channels 310a that include PDCCH, PDSCH, and PUSCH. The first portion of the physical channels 310a is received/transmitted based on the activated QCL/Beam ID for receiving the NCR-MT CORESET. The second portion of the physical channels 310b of PDCCH, PDSCH, PDSCH, and PUSCH is received/transmitted based on the indicated spatial information and beam ID for the NCR-MT DCI.

In this implementation, a determination is made whether the following conditions are present:
(i) the forwarded PDCCHs/PDSCHs/PUCCH/PUSCH (or the Backhaul DL/UL RF signal) are on a different component carrier than the NCR-MT; and
(ii) the controlling (or side control information) NCR-MT DCI has the TCI state/spatial QCL assumption/beam ID, or a spatial relation information field present, and
(iii) the time offset between receiving of that DCI and the corresponding PDCCHs/PDSCHs/PUCCHs/PUSCHs (or the backhaul DL/UL RF signal) of a serving cell is less than a threshold timeDurationForQCL,
where the threshold is based on the reported capability of the NCR-MT for decoding the side control information and applying the information on the forward link or NCR-Forward backhaul link, for determining the antenna port quasi co-location for receiving PDCCH/PDSCH (or the backhaul DL RF signal) and/or transmitting PUCCH/PUSCH/SRS (or the backhaul UL RF signal).

When these conditions are present, the NCR assumes that the TCI state/spatial QCL assumption/beam ID, or a spatial relation information for the forwarded PDCCH/PDSCH/PUCCH/PUSCH/SRS (or the backhaul DL/UL RF signal) on the NCR-Forward backhaul link is based on the TCI/QCL/beam ID (associated with the NCR-MT CORESET used for transmitting the side control information (e.g., in the latest slot).

In another example, if the forwarded PDCCHs/PDSCHs/PUCCHs/PUSCHs (or the backhaul DL/UL RF signal) are on a different component carrier than the NCR-MT and the controlling DCI having the TCI state/spatial QCL assumption/beam ID, or a spatial relation information field present, and the time offset between receiving of that DCI and the corresponding PDCCHs/PDSCHs/PUCCHs/PUSCHs of a serving cell is equal or greater than a threshold timeDurationForQCL, where the threshold is based on the reported capability of the NCR-MT for decoding the side control information and applying the information on the forward link, for determining the antenna port quasi co-location for receiving PDCCH/PDSCH and/or transmitting PUCCH/PUSCH/SRS, the NCR applies the TCI state/spatial QCL assumption/beam ID, or a spatial relation information indicated in the NCR-MT DCI.

In an alternative embodiment, if the forwarded PDCCHs/PDSCHs/PUCCHs/PUSCHs (or the backhaul DL/UL RF signal) are on the same component carrier as the NCR-MT, for determining the antenna port quasi co-location for receiving PDCCH/PDSCH and/or transmitting PUCCH/PUSCH/SRS, the NCR assumes that the TCI state/spatial QCL assumption/beam ID, or a spatial relation information for the forwarded PDCCH/PDSCH/PUCCH/PUSCH/SRS is based on the TCI/QCL/beam ID (associated with the NCR-MT CORESET used for transmitting the side control information within the active BWP of the serving cell).

In one embodiment, the NCR-MT transmits the forwarded PUCCH/PUSCH/SRS (or received UL signal on the NCR-Forward access link) with the same spatial domain transmission filter used for the reception of the forwarded PDCCH/PDSCH/DL RS (or backhaul DL signal on the NCR-Forward backhaul link). The NCR may receive unified DCI for both forwarded DL and UL, where a single TCI state/spatial relation information (or Joint TCI state) is indicated for both UL and DL of the forward (NCR-Forward) backhaul link.

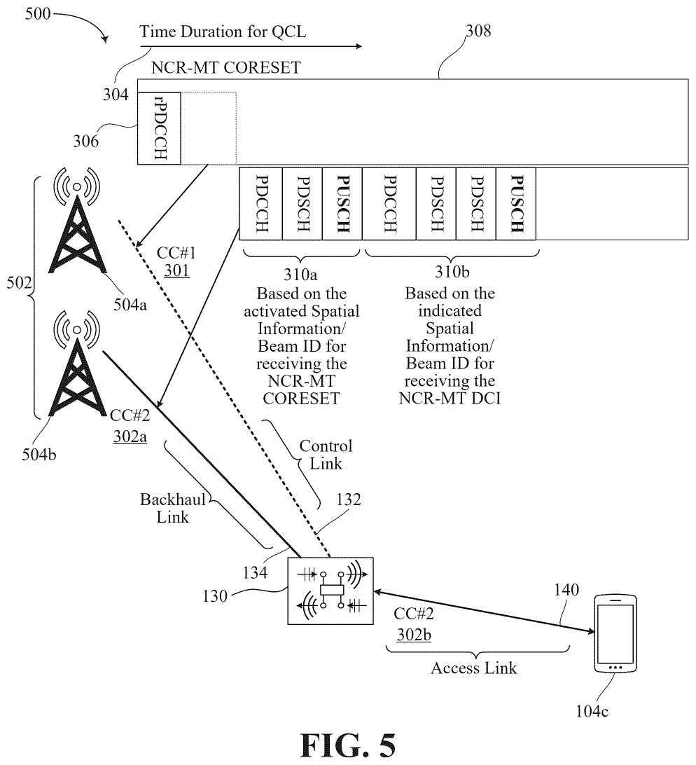

In a second embodiment (Embodiment 2), the present disclosure provides a beam indication for NCR backhaul link with a multiple Transmission and Reception Point (mTRP). FIG. 5 illustrates a communications system 500 as described for FIG. 4, but where the network device 102a is an mTRP 502 having a first TRP 504a that transmits the CC #1 301 on the control link 132 and having a second TRP 504b that transmits the CC #2 302a on the backhaul link 134. In one or more embodiments, for mTRP, the spatial information can be different even if the CCs for both links are the same. Whether the same CC or different CCS, for mTRP the spatial information of the backhaul link needs to be signaled or related to the control link.

According to embodiment 2, NCR-MT is configured with side control information carried by a CORESET from a TRP, wherein the CORESET associated with a TCI state/QCL assumption/beam ID carries DCI to control forwarded PDCCHs/PDSCHs/PUCCH/PUSCH (or backhaul DL/UL RF signal) received and/or transmitted from/to another TRP. A single NCR may be used to extend the coverage of multiple TRPs that belong to the same network. As the spatial information of receiving and/or transmitting from/to different TRPs is different, multiple TCI state/spatial QCL assumption/spatial relation information for the forward (NCR-Forward) backhaul link may be indicated in the NCR-MT DCI. Each is associated with a certain TRP.

If the forwarded PDCCHs/PDSCHs or PUCCH/PUSCH (or the backhaul DL/UL RF signal) are received/transmitted from a TRP different than the TRP used for controlling the NCR-MT and the controlling DCI has the TCI state/spatial QCL assumption/beam ID, or a spatial relation information present, and the time offset between receiving of that DCI and the corresponding PDCCHs/PDSCHs/PUCCHs/PUSCHs of a serving cell is equal or greater than a threshold timeDurationForQCL, where the threshold is based on the reported capability of the NCR-MT for decoding the side control information and applying the information on the forward link or NCR-Forward backhaul link, for determining the antenna port quasi co-location for receiving PDCCH/PDSCH (or the backhaul DL RF signal) and/or transmitting PUCCH/PUSCH/SRS (or the backhaul UL RF signal), the NCR-MT applies the TCI state/spatial QCL assumption/beam ID, or a spatial relation information in the NCR-MT DCI for the corresponding TRP associated with the spatial information.

In a third embodiment (Embodiment 3), the present disclosure provides for determining the timeDurationForQCL value when the NCR-MT and NCR-Forward are operating in different carriers and/or different TRPs. According to embodiment 3, NCR-MT is configured with side control information DCI carried by a CORESET, wherein the CORESET is associated with a TCI/QCL assumption/beam ID and time duration for the QCL (timeDurationForQCL e.g., in number of OFDM symbols) based on the reported capability of the NCR-MT for decoding and applying the side control information on the corresponding UL/DL slot(s). In one implementation, if NCR DCI carrying the side control information is received on a component carrier different than that of the forwarded (or NCR-Forward backhaul) link controlled by that DCI, an additional time delay (or offset) is added to the timeDurationForQCL of the NCR-MT. This may be the case if the subcarrier spacing of the forwarded PDCCH/PDSCH (or DL RF signal on the NCR-Forward backhaul link) is greater than the subcarrier spacing of the NCR-MT CORESET, wherein, in one example, the additional delay is proportional to the ratio between SCS of the forwarded PDCCH/PDSCH (or DL RF signal on the NCR-Forward backhaul link) and the SCS of the CORESET on the control link. In another implementation, if NCR DCI carrying the side control information is received on a component carrier different than that of the forwarded link (or NCR-Forward backhaul link) controlled by that DCI, no additional time delay is added to the timeDurationForQCL of the NCR-MT if the subcarrier spacing of the forwarded PDCCH/PDSCH (or DL RF signal on the NCR-Forward backhaul link) is less than or equal to the subcarrier spacing of the NCR-MT CORESET.

In one implementation, if NCR DCI carrying the side control information is received on a first TRP different than the second TRP of the forwarded (or NCR-Forward backhaul) link controlled by that DCI, an additional time delay (or offset) is added to the time DurationForQCL of the NCR-MT. This may be the case if the subcarrier spacing of the forwarded PDCCH/PDSCH (or DL RF signal on the NCR-Forward backhaul link from the second TRP) is greater than the subcarrier spacing of the NCR-MT CORESET from the first TRP. In another implementation, if NCR DCI carrying the side control information is received on a first TRP different than the second TRP of the forwarded link (or NCR-Forward backhaul link) controlled by that DCI, no additional time delay is added to the timeDurationForQCL of the NCR-MT if the subcarrier spacing of the forwarded PDCCH/PDSCH (or DL RF signal on the NCR-Forward backhaul link from the second TRP) is equal or less than the subcarrier spacing of the NCR-MT CORESET from the first TRP.

In a fourth embodiment (Embodiment 4), the present disclosure provides for PDCCH transmission over multiple carriers. According to one or more of the above embodiments, and in one implementation, base station transmits the NCR-MT DCI (rPDCCH) over the configured component carriers and/or using the multiple TRP for utilizing the frequency and/or spatial diversity for enhancing rPDCCH decoding performance. For determining the QCL assumption/spatial information for receiving PDCCH/PDSCH (or the backhaul DL RF signal) and transmitting PUCCH/PUSCH/SRS (or the backhaul UL RF signal), the NCR uses the QCL assumption/spatial information used for receiving the NCR CORESET for each of the component carriers.

In a first example a same set of fields of the NCR-MT DCI are transmitted over the configured component carriers and/or multiple TRPs. In a second example, the set of fields of the NCR-MT DCI are transmitted over one configured component carrier, and a subset of the set of fields of the NCR-MT DCI are transmitted over a remainder of the configured component carriers.

In another implementation, base station transmits pre-determined sequences over each component carrier and/or from each TRP to enable the NCR to determine the best Tx/Rx beam pair for receiving PDCCH/PDSCH (or the backhaul DL RF signal) and transmitting PUCCH/PUSCH/SRS (or the backhaul UL RF signal).

In yet another implementation, the base station transmits rPDCCH over one component carrier and based on the UL signaling over the Forward-link, it determines the relation between the beam corresponds to the one CC and all other beams corresponding to the other configured component carriers. Base station signals this information to NCR-MT for applying the corresponding spatial relation information for receiving/transmitting the forwarded physical channels. In one example, the signaled information is reported in a form of a set of at least one field of the NCR-MT DCI.

The present disclosure supports a method for wireless communication at an NCR device. The method includes receiving a configuration from the network for an NCR-MT control resource set (CORESET) containing an indicator for spatial information to be applied on the forward link or NCR-Forward backhaul link. The method includes monitoring the NCR CORESET and decoding the spatial relation information. The method includes determining whether to apply the spatial relation information on the forwarded physical channels or backhaul DL/UL RF signal of the backhaul link based on the offset between a DCI on the NCR-MT CORESET and the corresponding PDCCH/PDSCH/PUCCH/PUSCH or backhaul DL/UL RF signal on the NCR-Forward backhaul link.

In one or more embodiments, the indicator indicates to the repeater the spatial relation info, TCI, QCL assumption, and/or beam ID for receiving and transmitting the RF UL/DL signal in the backhaul link. In one or more embodiments, multiple spatial relation information is indicated in NCR-MT DCI for multiple component carriers of the forward link. In one or more embodiments, a single spatial relation information is indicated in NCR-MT DCI for both UL/DL of the backhaul forward link for each component carrier of the forward link.

In one or more embodiments, if the forwarded physical channels are on a different component carrier (CC) than the NCR-MT and the controlling DCI does not have the spatial relation information field present, the NCR assumes that the spatial relation information or the beam ID for the corresponding physical channels is based on the TCI/QCL/beam ID associated with the NCR-MT CORESET used for transmitting the side control information.

In one or more embodiments, if the forwarded physical channels are on a different component carrier (CC) than the NCR-MT and the controlling DCI has the spatial relation information field present, the NCR assumes that the relation information or the beam ID for the corresponding physical channels is based on the TCI/QCL/beam ID associated with the NCR-MT CORESET if the time offset between receiving of that CORESET and the corresponding PDCCHs/PDSCHs/PUCCHs/PUSCHs is less than a threshold timeDurationForQCL of the NCR-MT

In one or more embodiments, if the forwarded physical channels are on a different component carrier (CC) than the NCR-MT and the controlling DCI has the spatial relation information field present, the NCR applies the spatial relation information received on the DCI in the NCR-MT CORESET on the forwarded physical channels or backhaul DL/UL RF signal of the backhaul link if the time offset between receiving of that CORESET and the corresponding PDCCHs/PDSCHs/PUCCHs/PUSCHs is more than a threshold timeDurationForQCL of the NCR-MT.

In one or more embodiments, if the forwarded physical channels are on a different component carrier (CC) than the NCR-MT and the controlling DCI has the spatial relation information field present, the NCR applies the spatial information signaled in the DCI for both UL and DL transmission between the NCR and the base station.

In one or more embodiments, if the forwarded physical channels are on the same component carrier (CC) as the NCR-MT, the NCR doesn't expect to receive the spatial information in the DCI and applies the QCL assumption associated with the NCR-MT CORESET for receiving/transmitting the physical channels of on the forward backhaul link.

In one or more embodiments, multiple spatial relation information is indicated in NCR-MT DCI for the forwarded physical channels received/transmitted from/to multiple TRPs. In one or more embodiments, the time threshold timeDurationForQCL at the NCR is updated with additional delay if the subcarrier spacing of the forward link is larger than the subcarrier spacing of the C-link.

In one or more embodiments, the network device such as a base station transmits pre-determined sequences over each component carrier to enable the NCR to determine the best Tx/Rx beam pair for receiving PDCCH/PDSCH and transmitting PUCCH/PUSCH/SRS. In one or more embodiments, the base station transmits repeater PDCCH (rPDCCH) over one component carrier and, based on the UL signaling over the Forward-link, the base station determines the relation between the beam corresponds to the one CC and all other beams corresponding to the other configured component carriers.

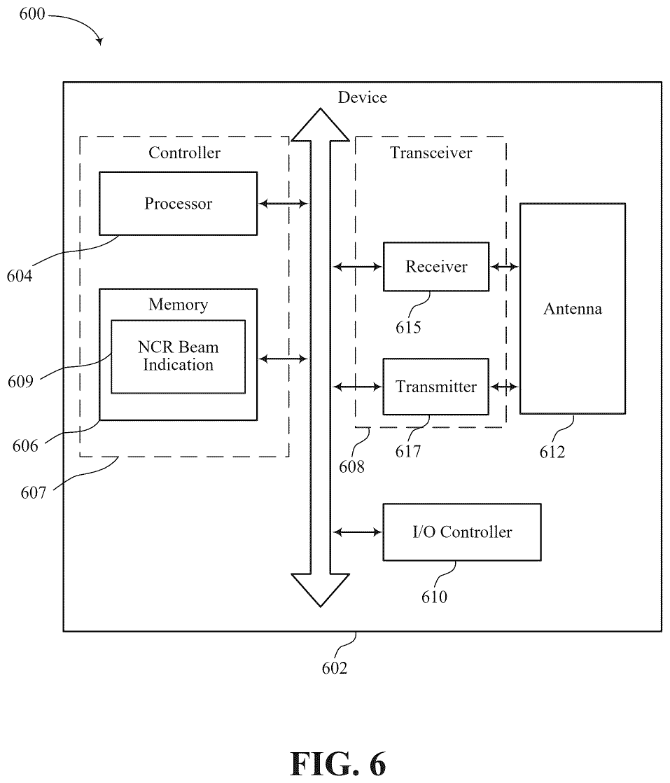

FIG. 6 illustrates an example of a block diagram 600 of a device 602 that supports beam indication for an NCR device, in accordance with aspects of the present disclosure. The device 602 may be an example of a network entity or network device 102 or a UE 104 (FIG. 1) as described herein. The device 602 may support wireless communication with one or more network entities or network devices 102, UEs 104, or any combination thereof. The device 602 may include components for bi-directional communications including components for transmitting and receiving communications, such as a processor 604, a memory 606, a transceiver 608, and an I/O controller 610. These components may be in electronic communication or otherwise coupled (e.g., operatively, communicatively, functionally, electronically, electrically) via one or more interfaces (e.g., buses).

The processor 604, the memory 606, the transceiver 608, or various combinations thereof or various components thereof may be examples of means for performing various aspects of the present disclosure as described herein. For example, the processor 604, the memory 606, the transceiver 608, or various combinations or components thereof may support a method for performing one or more of the operations described herein.

In some implementations, the processor 604, the memory 606, the transceiver 608, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some implementations, the processor 604 and the memory 606 coupled with the processor 604 (within a controller 607) may be configured to perform one or more of the functions as a controller 607, as described herein (e.g., executing, by the processor 604, instructions stored in the memory 606). In an example, the processor 604 of a device controller 614 executes an NCR beam indication application 609 to function as an NCR-MT in determining a beam indication for configuring a transceiver 608 of the device 602 to perform NCR forwarding.

The processor 604 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some implementations, the processor 604 may be configured to operate a memory array using a memory controller. In some other implementations, a memory controller may be integrated into the processor 604. The processor 604 may be configured to execute computer-readable instructions stored in a memory (e.g., the memory 606) to cause the device 602 to perform various functions of the present disclosure.

The memory 606 may include random access memory (RAM) and read-only memory (ROM). The memory 606 may store computer-readable, computer-executable code including instructions that, when executed by the processor 604 cause the device 602 to perform various functions described herein. The code may be stored in a non-transitory computer-readable medium such as system memory or another type of memory. In some implementations, the code may not be directly executable by the processor 604 but may cause a computer (e.g., when compiled and executed) to perform functions described herein. In some implementations, the memory 606 may include, among other things, a basic I/O system (BIOS) which may control basic hardware or software operation such as the interaction with peripheral components or devices.

The I/O controller 610 may manage input and output signals for the device 602. The I/O controller 610 may also manage peripherals not integrated into the device M02. In some implementations, the I/O controller 610 may represent a physical connection or port to an external peripheral. In some implementations, the I/O controller 610 may utilize an operating system such as iOS®, ANDROID®, MS-DOS®, MS-WINDOWS®, OS/2®, UNIX®, LINUX®, or another known operating system. In some implementations, the I/O controller 610 may be implemented as part of a processor, such as the processor 604. In some implementations, a user may interact with the device 602 via the I/O controller 610 or via hardware components controlled by the I/O controller 610.

In some implementations, the device 602 may include a single antenna 612. However, in some other implementations, the device 602 may have more than one antenna 612 (i.e., multiple antennas), including multiple antenna panels or antenna arrays, which may be capable of concurrently transmitting or receiving multiple wireless transmissions. The transceiver 608 may communicate bi-directionally using one or more receivers 615 and one or more transmitters 617, via the one or more antennas 612, wired, or wireless links as described herein. For example, the transceiver 608 may represent a wireless transceiver and may communicate bi-directionally with another wireless transceiver. The transceiver 608 may also include a modem to modulate the packets, to provide the modulated packets to one or more antennas 612 for transmission, and to demodulate packets received from the one or more antennas 612.

According to aspects of the present disclosure, the device 602 may be an NCR device 130 (FIGS. 1-6) for repeating wireless communication. The device 602 has the at least one transceiver 608 that includes at least one receiver 615 and at least one transmitter 617 that enable the device 602 to communicate with a network entity or network device 102a and to a user device such as UE 104a (FIG. 1). In particular, the at least one transceiver 608 enables the device 602 to communicate: (i) with at least one network device 102a (FIG. 1) of a wireless communications system 100 (FIG. 1) via (a) a control link 132 (FIGS. 1-5) or (b) a backhaul link 134 (FIGS. 1-5); and (ii) with a user device (UE 104a (FIG. 1)) via an access link 140 (FIGS. 1-5). A controller 607 of the device 602 is communicatively coupled to the at least one transceiver 608. The controller 607 receives, via a downlink control link from the wireless communications system 100 (FIG. 1), configuration information for a repeater control resource set (CORESET) containing an indicator of spatial relation information to be applied to the at least one transceiver 608 in transmitting a repeated signal via one of: (i) an uplink backhaul link 134 to the wireless communications system 100 (FIG. 1); and (ii) a forward access link 140 (FIGS. 1-5) to the user device. The controller 607 configures the at least one transceiver 608 with the configuration information to monitor the repeater CORESET received on the control link 132. The controller 607 decodes the spatial relation information based on the indicator. The controller 607 determines an offset between repeater downlink control information (DCI) on the repeater CORESET and a corresponding one of: (i) a physical channel received by the repeater device on the control link; or (ii) an Uplink (UL) radio frequency (RF) signal transmitted by the repeater device on the backhaul link; and (iii) a Downlink (DL) RF signal transmitted by the repeater device on the access link. The controller 607 applies the spatial relation information to the at least one transceiver in response to the offset being less than a threshold offset value.

In one or more embodiments, the repeater device is a network-controlled repeater (NCR) device. The controller 607 includes an NCR mobile terminal (MT) that communicates with the at least one network node via the control link 140 (FIGS. 1-5). The repeater CORESET is an NCR MT CORESET. In one or more embodiments, the physical channel received by the repeater device is via repeater physical downlink control channel (rPDCCH) on the first link, the UL RF signal transmitted by the repeater device is via one or more a physical uplink control channel (PUCCH) and a physical uplink shared channel (PUSCH) on the second link, and the DL RF signal transmitted by the repeater device is via one or more of a physical downlink control channel (PDCCH) and a physical downlink shared channel (PDSCH) on the third link.

In one or more embodiments, in applying the spatial relation information to the at least one transceiver, the controller 607 semi-statically configures the at least one transceiver with a default pattern of beams for more than one multiple Transmission and Reception Positions (TRPs) including a first TRP and a second TRP. The default pattern includes a periodic plurality of time slots. The default beam is periodically oriented towards the first TRP for a first integer number “M” of slots the plurality of time slots and then towards the second TRP for a second integer number “N” of slots of the plurality of time slots.

In one or more embodiments, the indicator of the spatial relation information applies to configuring the at least one transceiver to transmit on the access link to the user device. The controller 607 receives, via the backhaul link from the at least one network node, the DL RF signal to repeat. The controller 607 transmits the DL RF signal via the access link to the user device. In one or more embodiments, the controller 607 identifies, based on the indicator, one or more of transmission configuration indicator (TCI), quasi-colocation (QCL) assumption, and beam identifier (ID) for receiving and transmitting the UL and the DL RF signal respectively via the backhaul link. In one or more particular embodiments, in decoding the spatial relation information, the controller 607, in response to determining that forwarded physical channels are on a different component carrier (CC) than the repeater CORESET and the repeater DCI does not include a spatial relation information field, determines that spatial relation information or a beam identifier (ID) for a corresponding physical channel is based on one or more of the TCI, QCL, and beam ID associated with the repeater CORESET used for transmitting side control information.

In one or more particular embodiments, in decoding the spatial relation information, the controller 607, in response to determining that forwarded physical channels are on a different component carrier (CC) than the repeater CORESET and the repeater DCI does include a spatial relation information field, determines that spatial relation information or a beam identifier (ID) for a corresponding physical channel is based on one or more of the TCI, QCL, and beam ID associated with the repeater CORESET, when a time offset between receiving the repeater CORESET and the corresponding physical channels is less than a time duration for a QCL value associated with the repeater device.

In one or more particular embodiments, the controller 607, in response to determining that forwarded physical channels are on a same component carrier (CC) as the repeater CORESET: (i) determines that the repeater DCI does not include a spatial relation information field; (ii) identifies spatial information used to configure the transceiver to communicate via the control link; and (iii) applies QCL assumption to use the spatial information associated with the control link and the repeater CORESET for receiving and transmitting the physical channels on the backhaul link.

In one or more embodiments, the at least one network node comprises more than one network node at multiple transmission points (TRPs). Multiple spatial relation information is indicated in the repeater DCI for the forwarded physical channels received and transmitted respectively from and to multiple TRPs. In one or more embodiments, in decoding the spatial relation information, the controller 607: (i) decodes that a single spatial relation information is indicated in the repeater DCI for both the UL RF signal and the DL RF signal over the backhaul link for each component carrier; and (ii) applies the single spatial relation information to the transceiver for each component carrier to communicate via the backhaul link.

In one or more embodiments, the controller 607, in response to determining that forwarded physical channels are on a different component carrier (CC) than the repeater CORESET and the repeater DCI does include a spatial relation information field, determines the threshold offset value based on a time-duration-for-QCL value associated with the repeater device. In one or more particular embodiments, the controller 607 increases the time-duration-for-QCL value in response to determining that subcarrier spacing of the forward link is larger than subcarrier spacing of the control link. In one or more particular embodiments, the controller 607 the controller determines the threshold offset value based on the time-duration-for-QCL value associated with the repeater device further in response to determining that the repeater device does not support multiple panels.

In one or more embodiments, the controller 607, in response to determining that forwarded physical channels are on a different component carrier (CC) than the repeater CORESET and the repeater DCI does include a spatial relation information field, applies the spatial relation information received on the repeater DCI in the repeater CORESET for both of the UL RF signal and a DL RF signal communicated between the repeater device and the at least one network node.

In one or more embodiments, the controller 607 receives, from the network, at least one pre-determined sequence over each component carrier. The controller 607 determines a best transmit-receive pair for receiving a physical downlink control channel (PDCCH) and a physical downlink shared channel (PDSCH) for transmitting a physical uplink control channel (PDCCH), a physical uplink shared channel (PUSCH), and a sounding reference signal (SRS).

In one or more embodiments, the controller 607 receives, from the network, a repeater physical downlink control channel (rPDCCH) over one component carrier (CC) of more than one configured CC. The controller 607 configures the transceiver based on the rPDCCH. The controller 607 transmits UL RF signaling over the control link via the more than one configured CC to enable the at least one network node to determine a relationship between a beam that corresponds to the one CC and at least one other configured CC.

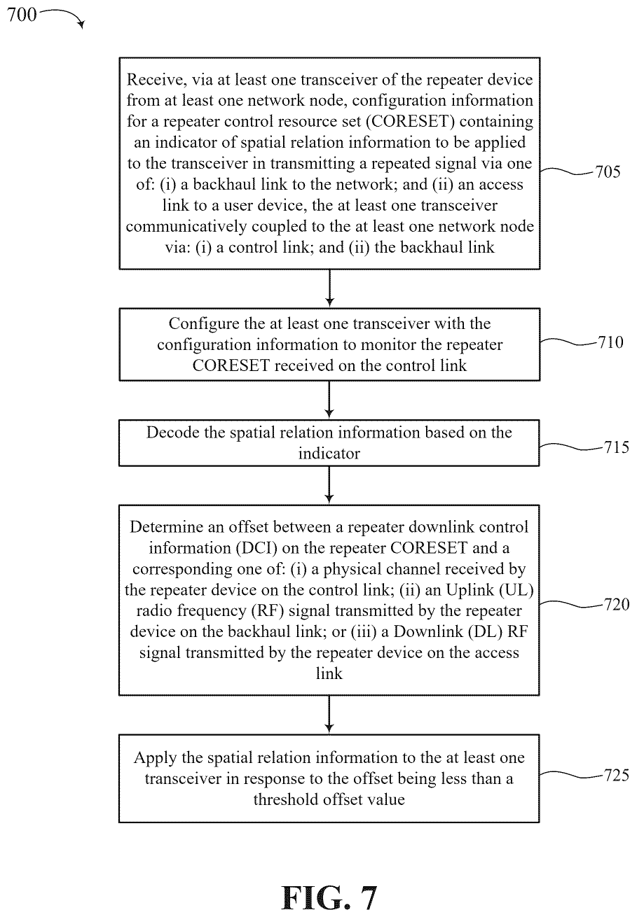

FIG. 7 illustrates a flowchart of a method 700 that enable an NCR device to determine a beam indication using a side control link, in accordance with aspects of the present disclosure. The operations of the method 700 may be implemented by a device or its components as described herein. For example, the operations of the method 700 may be performed by a repeater device such as NCR device 130 (FIGS. 1-5) or device 602 (FIG. 6). In some implementations, the user device may execute a set of instructions to control the function elements of the network device to perform the described functions. Additionally, or alternatively, the user device may perform aspects of the described functions using special-purpose hardware.

At 705, the method 700 may include receiving, via at least one transceiver of the repeater device from at least one network node, configuration information for a repeater control resource set (CORESET) containing an indicator of spatial relation information to be applied to the transceiver in transmitting a repeated signal via one of: (i) a backhaul link to the network; and (ii) an access link to a user device, the at least one transceiver communicatively coupled to the at least one network node via: (i) a control link; and (ii) the backhaul link. The operations of 705 may be performed in accordance with examples as described herein. In some implementations, aspects of the operations of 705 may be performed by a device as described with reference to FIGS. 1-6.

At 710, the method 700 may include configuring the at least one transceiver with the configuration information to monitor the repeater CORESET received on the control link. The operations of 710 may be performed in accordance with examples as described herein. In some implementations, aspects of the operations of 710 may be performed by a device as described with reference to FIGS. 1-6.

At 715, the method 700 may include decoding the spatial relation information based on the indicator. The operations of 715 may be performed in accordance with examples as described herein. In some implementations, aspects of the operations of 715 may be performed by a device as described with reference to FIGS. 1-6.

At 720, the method 700 may include determining an offset between a repeater downlink control information (DCI) on the repeater CORESET and a corresponding one of: (i) a physical channel received by the repeater device on the control link; (ii) an Uplink (UL) radio frequency (RF) signal transmitted by the repeater device on the backhaul link; or (iii) a Downlink (DL) RF signal transmitted by the repeater device on the access link. The operations of 720 may be performed in accordance with examples as described herein. In some implementations, aspects of the operations of 720 may be performed by a device as described with reference to FIGS. 1-6.

At 725, the method 700 may include applying the spatial relation information to the at least one transceiver in response to the offset being less than a threshold offset value. The operations of 725 may be performed in accordance with examples as described herein. In some implementations, aspects of the operations of 725 may be performed by a device as described with reference to FIGS. 1-6.

In one or more embodiments, the repeater device is a network-controlled repeater (NPR) device. The repeater CORESET is an NCR mobile terminal (MT) CORESET. The method 700 may include communicating with the at least one network node via the control link using an NCR MT. In one or more embodiments, the physical channel received by the repeater device is via repeater physical downlink control channel (rPDCCH) on the first link, the UL RF signal transmitted by the repeater device is via one or more a physical uplink control channel (PUCCH) and a physical uplink shared channel (PUSCH) on the second link, and the DL RF signal transmitted by the repeater device is via one or more of a physical downlink control channel (PDCCH) and a physical downlink shared channel (PDSCH) on the third link.

In one or more embodiments, applying the spatial relation information to the at least one transceiver includes semi-statically configures the at least one transceiver with a default pattern of beams for more than one multiple Transmission and Reception Positions (TRPs) that includes a first TRP and a second TRP. The default pattern comprising a periodic plurality of time slots, wherein the default beam is periodically oriented towards the first TRP for a first integer number “M” of slots the plurality of time slots and then towards the second TRP for a second integer number “N” of slots of the plurality of time slots.

In one or more embodiments, the indicator of the spatial relation information identifies configuration details for the at least one transceiver to transmit on the access link to the user device. The method 700 may further include receiving, from the at least one network node via the backhaul link, the DL RF signal to repeat; and transmitting the DL RF signal via the access link to the user device.

In one or more embodiments, the method 700 may include identifying, based on the indicator, one or more of transmission configuration indicator (TCI), quasi-colocation (QCL) assumption, and beam identifier (ID) for receiving and transmitting the UL and the DL RF signals respectively via the backhaul link.

In one or more embodiments, the method 700 may include decoding the spatial relation information by, in response to determining that forwarded physical channels are on a different component carrier (CC) than the repeater CORESET and the repeater DCI does not include a spatial relation information field, determining that spatial relation information or a beam identifier (ID) for a corresponding physical channel is based on one or more of the TCI, QCL, and beam ID associated with the repeater CORESET used for transmitting side control information.

In one or more embodiments, the method 700 may include decoding the spatial relation information by, in response to determining that forwarded physical channels are on a different component carrier (CC) than the repeater CORESET and the repeater DCI does include a spatial relation information field, basing the spatial relation information or a beam identifier (ID) for a corresponding physical channel on one or more of the TCI, QCL, and beam ID associated with the repeater CORESET, when a time offset between receiving the repeater CORESET and the corresponding physical channels is less than a time duration for a QCL value associated with the repeater device.

In one or more embodiments, the method 700 may include, in response to determining that forwarded physical channels are on a same component carrier (CC) as the repeater CORESET: (i) determining that the repeater DCI does not include a spatial relation information field; (ii) identifying spatial information used to configure the transceiver to communicate via the control link; and (iii) applying QCL assumption to use the spatial information associated with the control link and the repeater CORESET for receiving and transmitting the physical channels on the backhaul link.

In one or more embodiments, the at least one network node comprises more than one network node at multiple transmission points (TRPs). The method 700 may include receiving an indication of multiple spatial relation information in the repeater DCI for forwarded physical channels received and transmitted respectively from and to the multiple TRPs.

In one or more embodiments, the method 700 may include decoding the spatial relation information by: (i) identifying that a single spatial relation information is indicated in the repeater DCI for both the UL RF signal and the DL RF signal over the backhaul link for each component carrier; and (ii) applying the single spatial relation information to the transceiver for each component carrier to communicate via the backhaul link.

In one or more embodiments, the method 700 may include, in response to determining that forwarded physical channels are on a different component carrier (CC) than the repeater CORESET and the repeater DCI does include a spatial relation information field, determining the threshold offset value based on a time-duration-for-QCL value associated with the repeater device. In one or more particular embodiments, the method 700 may include increasing the time-duration-for-QCL value in response to determining that subcarrier spacing of the forward link is larger than subcarrier spacing of the control link. In one or more particular embodiments, determining the threshold offset value based on the time-duration-for-QCL value associated with the repeater device is further in response to determining that the repeater device does not support multiple panels.

In one or more embodiments, the method 700 may include, in response to determining that forwarded physical channels are on a different component carrier (CC) than the repeater CORESET and the repeater DCI does include a spatial relation information field, applying the spatial relation information received on the repeater DCI in the repeater CORESET for both of the UL and the DL RF signal communicated between the repeater device and the at least one network node.

In one or more embodiments, the method 700 may include receiving, from the network, at least one pre-determined sequence over each component carrier (CC). The method 700 may include measuring one or more of received signal power and quality the at least one pre-determined sequence over each CC. The method 700 may include comparing measurements for each CC. The method 700 may include determining a best transmit-receive pair for receiving a physical downlink control channel (PDCCH) and a physical downlink shared channel (PDSCH) for transmitting a physical uplink control channel (PDCCH), a physical uplink shared channel (PUSCH), and a sounding reference signal (SRS).

In one or more embodiments, the method 700 may include receiving, from the at least one network node, a repeater physical downlink control channel (rPDCCH) over one component carrier (CC) of more than one configured CC. The method 700 may include configuring the transceiver based on the rPDCCH. The method 700 may include transmitting uplink RF signaling over the control link via the more than one configured CC to enable the at least one network node to determine a relationship between a beam that corresponds to the one CC and at least one other configured CC.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor.

Any connection may be properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on. Further, as used herein, including in the claims, a “set” may include one or more elements.

The terms “transmitting,” “receiving,” or “communicating,” when referring to a network entity, may refer to any portion of a network entity (e.g., a base station, a CU, a DU, a RU) of a RAN communicating with another device (e.g., directly or via one or more other network entities).

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form to avoid obscuring the concepts of the described example.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. A repeater device for wireless communication, the repeater device comprising:
a memory; and
a processor communicatively coupled to the memory and which is configured to cause the repeater device to:
receive, via a first link from a network, configuration information for a repeater control resource set (CORESET) containing an indicator of spatial relation information to be applied in transmitting a repeated signal via one of: (i) a second link to the network; and (ii) a third link to a user equipment (UE);
configure the repeater device with the configuration information to monitor the repeater CORESET received on the first link;
decode the spatial relation information based on the indicator;
determine an offset between repeater downlink control information (DCI) on the repeater CORESET and a corresponding one of: (i) a physical channel received by the repeater device on the first link; or (ii) an Uplink (UL) radio frequency (RF) signal transmitted by the repeater device on the second link; and (iii) a Downlink (DL) RF signal transmitted by the repeater device on the third link; and
apply quasi-colocation (QCL) assumption to use the spatial information associated with the first link and the repeater CORESET for receiving and transmitting the physical channels on the second link.

2. The repeater device of claim 1, wherein:
the repeater device comprises a network-controlled repeater (NCR) device;
the first link comprises a control link that is a DL from the network;
the second link comprises a backhaul link;
the third link comprises an access link to the UE;
the NCR comprises an NCR mobile terminal (MT) that communicates with the at least one network node via the first link; and
the repeater CORESET comprises an NCR MT CORESET.

3. The repeater device of claim 2, wherein:
the physical channel received by the repeater device is received via a repeater physical downlink control channel (rPDCCH) on the first link;
the UL RF signal transmitted by the repeater device is transmitted via one or more a physical uplink control channel (PUCCH) and a physical uplink shared channel (PUSCH) on the second link; and
the DL RF signal transmitted by the repeater device is transmitted via one or more of a physical downlink control channel (PDCCH) and a physical downlink shared channel (PDSCH) on the third link.

4. The repeater device of claim 1, further comprising at least one transceiver communicatively coupled to the processor and wherein, in applying the spatial relation information, the processor is configured to cause the repeater device to semi-statically configure the at least one transceiver with a default pattern of beams for more than one multiple Transmission and Reception Positions (TRPs) comprising a first TRP and a second TRP, the default pattern comprising a periodic plurality of time slots, wherein the default beam is periodically oriented towards the first TRP for a first integer number “M” of slots the plurality of time slots and then towards the second TRP for a second integer number “N” of slots of the plurality of time slots.

5. The repeater device of claim 1, wherein:
the indicator of the spatial relation information applies to configuring the repeater device to transmit on the third link to the UE; and
the processor is further configured to cause the repeater device to:
receive, via the second link from the network, the DL RF signal to repeat; and
transmit the DL RF signal via the third link to the UE.

6. The repeater device of claim 1, wherein the processor is further configured to cause the repeater device to identify, based on the indicator, one or more of transmission configuration indicator (TCI), QCL assumption, and beam identifier (ID) for receiving and transmitting the UL and the DL RF signal respectively via the second link.

7. The repeater device of claim 6, wherein, in decoding the spatial relation information, the processor is further configured to cause the repeater device to:
in response to determining that forwarded physical channels are on a different component carrier (CC) than the repeater CORESET and the repeater DCI does not include a spatial relation information field, determine that spatial relation information or a beam identifier (ID) for a corresponding physical channel is based on one or more of the TCI, QCL, and beam ID associated with the repeater CORESET used for transmitting side control information.

8. The repeater device of claim 7, wherein the processor is further configured to cause the repeater device to:
determine that spatial relation information or a beam identifier (ID) for a corresponding physical channel is based on one or more of the TCI, QCL, and beam ID associated with the repeater CORESET, when a time offset between receiving the repeater CORESET and the corresponding physical channels is less than a time duration for a QCL value associated with the repeater device.

9. (canceled)

10. The repeater device of claim 1, wherein, in decoding the spatial relation information, the processor is further configured to cause the repeater device to:
decode that a single spatial relation information is indicated in the repeater DCI for both the UL RF signal and the DL RF signal over the second link for multiple component carriers; and
apply the single spatial relation information to each of the multiple component carriers to communicate via the second link.

11. The repeater device of claim 1, wherein, the processor is further configured to cause the repeater device to:
in response to determining that forwarded physical channels are on a different component carrier (CC) than the repeater CORESET and the repeater DCI does include a spatial relation information field:
determine the threshold offset value based on a time-duration-for-QCL value associated with the repeater device; and
increase the time-duration-for-QCL value in response to determining that subcarrier spacing of the forward link is larger than subcarrier spacing of the first link.

12. (canceled)

13. (canceled)

14. The repeater device of claim 1, wherein, the processor is further configured to cause the repeater device to:
receive, from the network, at least one pre-determined sequence over each component carrier; and
determine a best transmit-receive pair for receiving a physical downlink control channel (PDCCH) and a physical downlink shared channel (PDSCH) for transmitting a physical uplink control channel (PDCCH), a physical uplink shared channel (PUSCH), and a sounding reference signal (SRS).

15. The repeater device of claim 1, further comprising a transceiver communicatively coupled to the processor, wherein the processor is further configured to cause the repeater device to:
receive, from the network, a repeater physical downlink control channel (rPDCCH) over one component carrier (CC) of more than one configured CC;
configure the transceiver based on the rPDCCH; and
transmit UL RF signaling over the first link via the more than one configured CC to enable the at least one network node to determine a relationship between a beam that corresponds to the one CC and at least one other configured CC.

16. A controller for wireless communication by a repeater device, the controller comprising:
at least one processor communicatively coupled to at least one memory and configured to cause the controller to:
receive, via a downlink first link from the network, configuration information for a repeater control resource set (CORESET) containing an indicator of spatial relation information to be applied in transmitting a repeated signal via one of: (i) an uplink second link to the network; and (ii) a forward third link to the user device;
configure the at least one transceiver with the configuration information to monitor the repeater CORESET received on the first link;
decode the spatial relation information based on the indicator;
determine an offset between repeater downlink control information (DCI) on the repeater CORESET and a corresponding one of: (i) a physical channel received by the repeater device on the first link; or (ii) an Uplink (UL) radio frequency (RF) signal transmitted by the repeater device on the second link; and (iii) a Downlink (DL) RF signal transmitted by the repeater device on the third link; and
apply quasi-colocation (QCL) assumption to use the spatial information associated with the first link and the repeater CORESET for receiving and transmitting the physical channels on the second link.

17. The controller of claim 16, wherein the at least one processor is further configured to cause the controller to:
identify, based on the indicator, one or more of transmission configuration indicator (TCI), QCL assumption, and beam identifier (ID) for receiving and transmitting the UL and the DL RF signals respectively via the second link; and
wherein to decode the spatial relation information the at least one processor causes the controller to:
in response to determining that forwarded physical channels are on a different component carrier (CC) than the repeater CORESET and the repeater DCI does not include a spatial relation information field, determine that spatial relation information or a beam identifier (ID) for a corresponding physical channel is based on one or more of the TCI, QCL, and beam ID associated with the repeater CORESET used for transmitting side control information; and
in response to determining that forwarded physical channels are on a different component carrier (CC) than the repeater CORESET and the repeater DCI does include a spatial relation information field, base the spatial relation information or a beam identifier (ID) for a corresponding physical channel on one or more of the TCI, QCL, and beam ID associated with the repeater CORESET, when a time offset between receiving the repeater CORESET and the corresponding physical channels is less than a time duration for a QCL value associated with the repeater device.

18. A method for wireless communication by a repeater device, the method comprising:
receiving, from at least one network node of a network, configuration information for a repeater control resource set (CORESET) containing an indicator of spatial relation information to be applied to the repeater device in transmitting a repeated signal via one of: (i) a second link to the network; and (ii) an third link to a user device, the at least one transceiver communicatively coupled to the at least one network node via: (i) a first link; and (ii) the second link;
configuring the repeater device with the configuration information to monitor the repeater CORESET received on the first link;
decoding the spatial relation information based on the indicator;
determining an offset between a repeater downlink control information (DCI) on the repeater CORESET and a corresponding one of: (i) a physical channel received by the repeater device on the first link; (ii) an Uplink (UL) radio frequency (RF) signal transmitted by the repeater device on the second link; or (iii) a Downlink (DL) RF signal transmitted by the repeater device on the third link; and
applying quasi-colocation (QCL) assumption to use the spatial information associated with the first link and the repeater CORESET for receiving and transmitting the physical channels on the second link.

19. The method of claim 18, wherein applying the spatial relation information comprises semi-statically configuring at least one transceiver of the repeater device with a default pattern of beams for more than one multiple Transmission and Reception Positions (TRPs) comprising a first TRP and a second TRP, the default pattern comprising a periodic plurality of time slots, wherein the default beam is periodically oriented towards the first TRP for a first integer number “M” of slots the plurality of time slots and then towards the second TRP for a second integer number “N” of slots of the plurality of time slots.

20. The method of claim 18, further comprising:
identifying, based on the indicator, one or more of transmission configuration indicator (TCI), QCL assumption, and beam identifier (ID) for receiving and transmitting the UL and the DL RF signals respectively via the second link; and
wherein decoding the spatial relation information comprises:
in response to determining that forwarded physical channels are on a different component carrier (CC) than the repeater CORESET and the repeater DCI does not include a spatial relation information field, determining that spatial relation information or a beam identifier (ID) for a corresponding physical channel is based on one or more of the TCI, QCL, and beam ID associated with the repeater CORESET used for transmitting side control information; and
in response to determining that forwarded physical channels are on a different component carrier (CC) than the repeater CORESET and the repeater DCI does include a spatial relation information field, basing the spatial relation information or a beam identifier (ID) for a corresponding physical channel on one or more of the TCI, QCL, and beam ID associated with the repeater CORESET, when a time offset between receiving the repeater CORESET and the corresponding physical channels is less than a time duration for a QCL value associated with the repeater device.

21. The controller of claim 16, wherein, in applying the spatial relation information, the processor is configured to cause the controller to semi-statically configure at least one transceiver with a default pattern of beams for more than one multiple Transmission and Reception Positions (TRPs) comprising a first TRP and a second TRP, the default pattern comprising a periodic plurality of time slots, wherein the default beam is periodically oriented towards the first TRP for a first integer number “M” of slots the plurality of time slots and then towards the second TRP for a second integer number “N” of slots of the plurality of time slots.

22. The controller of claim 16, wherein:
the indicator of the spatial relation information applies to configuring the controller to transmit on the third link to the UE; and
the processor is further configured to cause the controller to:
receive, via the second link from the network, the DL RF signal to repeat; and
transmit the DL RF signal via the third link to the UE.

23. The controller of claim 1, wherein the processor is further configured to cause the controller to identify, based on the indicator, one or more of transmission configuration indicator (TCI), quasi-colocation (QCL) assumption, and beam identifier (ID) for receiving and transmitting the UL and the DL RF signal respectively via the second link.
